(19) United States
(12) Patent Application Publication
(10) Pub. No.: US 2017/0316149 A1
(43) Pub. Date: Nov. 2, 2017

(54) CLASSIFICATION OF GENETIC VARIANTS

(71) Applicant: Quest Diagnostics Investments Inc., Wilmington, DE (US)

(72) Inventor: Glenn A. Maston, Hudson, MA (US)

(73) Assignee: Quest Diagnostics Investments Inc., Wilmington, DE (US)

(21) Appl. No.: 15/582,464

(22) Filed: Apr. 28, 2017

Related U.S. Application Data
(60) Provisional application No. 62/328,733, filed on Apr. 28, 2016.

(51) Int. Cl. G06F 19/18; G06F 19/00

(52) U.S. Cl. CPC G06F 19/18; G06F 19/345; G06F 19/3431

(57) ABSTRACT

DNA variants may be classified according to a rules-based scoring system into five categories that include pathogenic, likely pathogenic, variant of unknown significance, likely benign, and benign. Scores may be associated with variants in a framework that weighs evidence from prediction tools, population frequency, co-occurrence, segregation, and functional studies. A standardized scoring system for assessing pathogenicity may provide reliable, consistent pathogenicity scores for DNA variants encountered in a clinical laboratory setting.

### CROSS-REFERENCE TO RELATED APPLICATION

This application claims the benefit of provisional U.S. patent application No. 62/328,733, filed on 28 Apr. 2017 and titled “Classification of Genetic Variants”, which is hereby incorporated herein by reference.

### BACKGROUND

Genetic testing is fast becoming a formidable tool for diagnosing common and rare diseases. Many specific genes in the human genome cause Mendelian disorders, and many common diseases are associated with a constellation of genes harboring risk factors. Identifying disease genes lets research move beyond searching for a cause to seeking a cure. As gene-specific therapies are developed, it will become increasingly important to identify which genetic variants provide diagnostic and prognostic information.

Existing technologies permit rapid sequencing of disease-targeted multigene panels, the exome, and the entire genome, but they do not address the growing problem of interpreting the clinical significance of variants uncovered during the course of diagnostic testing.

Several schemes for reporting clinical variants have been proposed for cancer. See Eggington, et al., A Comprehensive Laboratory-Based Program for Classification of Variants of Uncertain Significance in Hereditary Cancer Genes, 86 CLINICAL GENETICS 229 (2014), http://dx.doi.org/10.1111/cge.12315; Goldgar, et al., Integrated Evaluation of DNA Sequence Variants of Unknown Clinical Significance: Application to BRCA1 and BRCA2, 75 AM. J. HUM. GENETICS 535 (2004), http://dx.doi.org/10.1086/424388; Lindor, et al., A Review of a Multifactorial Probability-Based Model for Classification of BRCA1 and BRCA2 Variants of Uncertain Significance (VUS), 33 HUM. MUTATION 8 (2012), http://dx.doi.org/10.1002/humu.21627; Pastrello, et al., Integrated Analysis of Unclassified Variants in Mismatch Repair Genes, 13 GENETICS IN MED. 115 (2011), http://dx.doi.org/10.1097/GIM.0b013e3182011489; Pion, et al., Sequence Variant Classification and Reporting: Recommendations for Improving the Interpretation of Cancer Susceptibility Genetic Test Results, 29 HUM. MUTATION 1282 (2008), http://dx.doi.org/10.1002/humu.20880; Thompson, et al., Application of a 5-Tiered Scheme for Standardied Classification of 2,360 Unique Mismatch Repair Gene Variants in the InSiGHT Locus-Specific Database, 46 NATURE GENETICS 107 (2014), http://dx.doi.org/10.1038/ng.2854.

A scheme has been proposed for reporting variants in the mitochondrial genome. See Wang, et al., an Integrated Approach for Classifying Mitochondrial DNA Variants: One Clinical Diagnostic Laboratory's Experience, 14 GENETICS IN MED. 620 (2012), http://dx.doi.org/10.1038/gim.2012.4.

And schemes have been proposed for reporting non-specific mutations. See Bean, et al., Free the Data: One Laboratory's Approach to Knowledge-Based Genomic Variant Classification and Preparation for EMR Integration of Genomic Data, 34 HUM. MUTATION 1183 (2013), http://dx.doi.org/10.1002/humu.22364; Duzkale, et al., A Systematic Approach to Assessing the Clinical Significance of Genetic Variants, 84 CLINICAL GENETICS 453 (2013), http://dx.doi.org/10.1111/cge.12257; Kircher, et al., A General Framework for Estimating the Relative Pathogenicity of Human Genetic Variants, 46 NATURE GENETICS 310 (2014), http://dx.doi.org/10.1038/ng.2892.

Recently, the American College of Medical Genetics and Genomics (ACMG) and the Association for Molecular Pathology (AMP) updated guidance for the interpretation of sequence variants in clinical laboratories. See Sue Richards et al., Standards and Guidelines for the Interpretation of Sequence Variants: A Joint Consensus Recommendation of the American College of Medical Genetics and Genomics and the Association for Molecular Pathology, 17 GENETICS IN MEDICINE 405, 405 (May 2015), http://dx.doi.org/10.1038/gim.2015.30. Richards lists five terms-“pathogenic”, “likely pathogenic”, “uncertain significance”, “likely benign”, and “benign”—to describe variants identified in genes that cause Mendelian disorders. Id.

According to existing schemes, including those described in the references cited above, classifying a variant depends substantially on the opinion of the trained geneticist who is making the classification. Although some guidelines may assist in the consideration, classifying a variant nonetheless requires substantial time and effort on the part of an expert such as, for example, a physician who has been board-certified by the ACMG.

One alternative to existing practice would be creation of a point system, according to which, for example, a variant would be evaluated under several objective criteria, each criterion contributing to a score according to its likely association with pathogenic or benign variants, and the total score would be used to determine the classification of the variant. Such a system, if it could be created, would allow variants to be classified more quickly and less expensively than current practice allows. But the consensus in the art has been that current understanding does not permit creation of such a system. See Richards at 406 (“[W]hile the majority of respondents did favor a point system, the workgroup felt that the assignment of specific points for each criterion implied a quantitative level of understanding of each criterion that is currently not supported scientifically and does not take into account the complexity of interpreting genetic evidence.”).

### BRIEF SUMMARY

Embodiments of the invention include apparatus, systems, and methods for classifying genetic variants. According to embodiments of the invention, a standardized, rules-based process may provide a variant pathogenicity risk score based on clinical grade information in a CLIA-certified laboratory. Such a standardized system may provide reliable pathogenicity scores for DNA variants encountered in a clinical laboratory setting.

For example, in an embodiment of the invention, a sample of DNA may be obtained from a patient, who may or may not have been diagnosed with a disease or other medical condition. From the sample, the patient's genome may be sequenced in whole or in part. The result of sequencing may then be compared, e.g., to one or more reference genomes to identify variants in the patient's genome. One or more of the variants may be compared to databases of known variants. The result of that comparison may be identification of one or more previously unknown variants, one or more variants that are known but unclassified, or both.

According to embodiments of the invention, an unclassified variant may be evaluated against one or more objective criteria. For example, in an embodiment, an embodiment may be assigned a starting score. Application of one or more objective criteria may cause additions and subtractions from the score, leading to a final score that may be used to classify the variant. In embodiments of the invention, classification of one or more previously-classified variants may be revisited, e.g., periodically, to reevaluate the variants in light of new information gained since the previous evaluation.

According to an embodiment of the invention, a method of assigning a score to a genetic variant is based on multiple scoring criteria and reflects an estimate of pathogenicity of the variant. The method comprises identifying the variant in sequenced DNA obtained from a patient and assigning a starting score to the variant, where the starting score is a single numeric value that is associated with variants of unknown significance.

The method also comprises: calculating a first score adjustment that is based on objective evaluation of minor evidence and splicing predictions; calculating a second score adjustment that is based on objective evidence of the frequency with which the variant occurs in a general population; calculating a third score adjustment that is based on objective evidence of the frequency with which the variant occurs in clinically characterized patients; calculating a fourth score adjustment that is based on objective evidence of the frequency with which the variant has been observed to co-occur with one or more other variants that are known to be pathogenic; calculating a fifth score adjustment that is based on objective evidence of a degree to which the variant exhibits segregation within one or more families; calculating a sixth score adjustment that is based on objective evidence of association between the variant and one or more disease phenotypes within data describing one or more families; and calculating a seventh score adjustment based on objective evidence regarding whether the variant affects functions of one or more proteins that are known to be associated with disease.

The method also comprises calculating a variant score based on the starting value, the first score adjustment, the second score adjustment, the third score adjustment, the fourth score adjustment, the fifth score adjustment, the sixth score adjustment, and the seventh score adjustment, the variant score being a single numeric value. And the method comprises assigning the variant to an assigned classification based solely on the variant score, where the assigned classification is one of a group that consists of a plurality of classifications, each classification in the plurality being associated with a respective different evaluation of variant pathogenicity.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 illustrates, in overview, a process for evaluating a genetic variant according to an embodiment of the invention.

FIG. 2 depicts a classification scheme used in connection with embodiments of the invention.

FIG. 3 is a high-level depiction of a flow that includes evaluating variants in connection with embodiments of the invention.

FIGS. 4a-4c depict, as a flow, scoring a variant according to minor evidence and splicing predictions according to an embodiment of the invention.

FIGS. 5a-5b depict, as a flow, scoring a variant according to the frequency with which it occurs in the general population according to an embodiment of the invention.

FIG. 6 depicts, as a flow, scoring a variant according to the relative frequency of the variant in clinically characterized patients according to an embodiment of the invention.

FIG. 7 depicts, as a flow, scoring a variant according to its co-occurrence with other variants that are known to be pathogenic, according to an embodiment of the invention.

FIG. 8 depicts, as a flow, scoring a variant according to its segregation within families, according to an embodiment of the invention.

FIG. 9 depicts, as a flow, scoring a variant according to its association with disease phenotypes in family data, according to an embodiment of the invention.

FIG. 10 depicts, as a flow, scoring a variant according to its effect on the structure and function of a protein that it encodes, according to an embodiment of the invention.

FIG. 11 depicts conceptually elements of a computer system in connection with an embodiment of the invention.

FIG. 12 depicts conceptually elements of internetworked computer systems in connection with an embodiment of the invention.

### DETAILED DESCRIPTION OF THE PREFERRED EMBODIMENTS

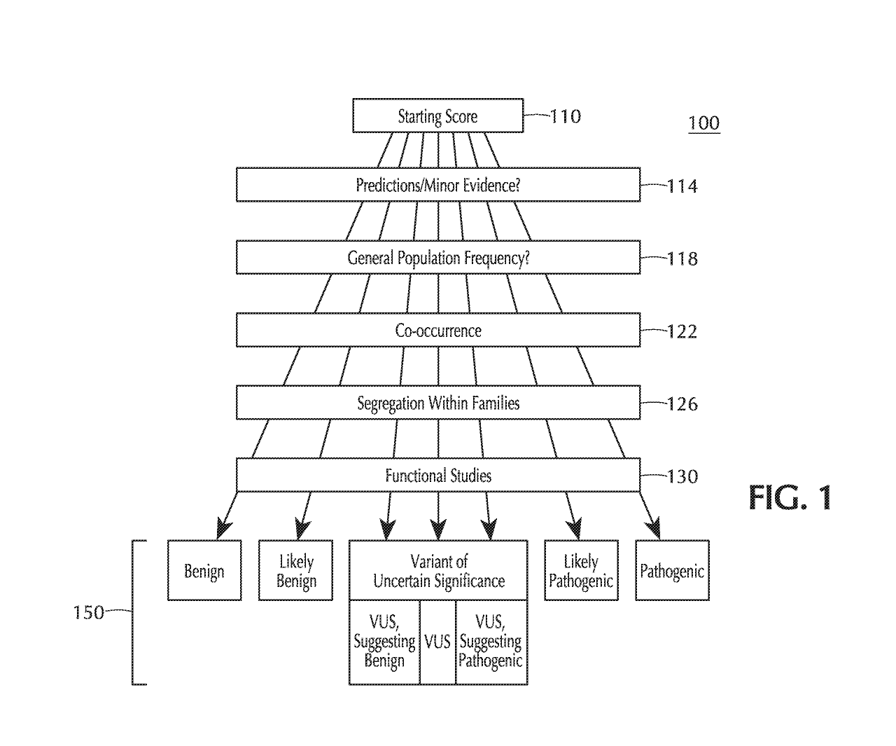

FIG. 1 depicts, conceptually, a scheme 100 for scoring variants according to embodiments of the invention. The depicted scheme may assign to a variant a numeric score, e.g., in the range of 1 (benign) to 7 (pathogenic). As depicted, a variant begins with a starting score 110, which may be at the middle of the range in an embodiment of the invention. For example, if a scale of 1 to 7 is used, each variant may initially receive a score of 4.

As FIG. 1 depicts, in embodiments of the invention, a variant may then be scored according to several criteria. For example, as FIG. 1 depicts, a variant may be scored based on minor evidence and splicing predictions (block 114), frequency of the variant in the general population (block 118), co-occurrence of the variant with other variants that are known to be pathogenic (block 122), segregation of the variant within families (block 126), and functional studies (block 130). Alternative embodiments of the invention may omit one or more of these criteria, or they may apply additional criteria in addition to or instead of any one or more of these criteria. Consequent to the application of the criteria, the variant may receive a combined score, according to which the variant may be classified according to a scheme 150.

The depiction in FIG. 1 is conceptual. It will be appreciated that one or more criteria may be applied in an order or with a relationship that differs from what FIG. 1 depicts.

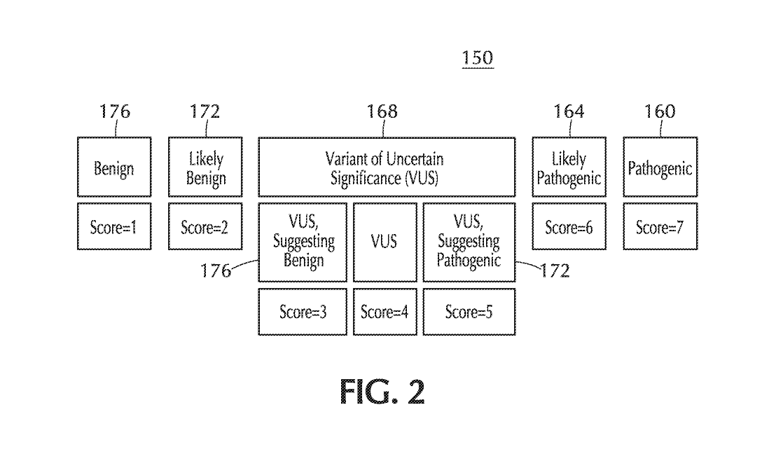

FIG. 2 depicts the classification part 150 of the scheme 100, in connection with an embodiment of the invention, in more detail. The depicted scheme 150, which may be used in connection with embodiments of the invention, may be consistent with (but not identical to) one recommended in Richards, supra. The depicted scheme uses a 7-point scale with 3 subclasses in the variant of unknown significance (VUS) category 168. The depicted classifications include pathogenic (score-7) 160, likely pathogenic (score-6) 164, VUS (score-3 to 5) 168, likely benign (score-2) 172, and benign (score-1) 176. The VUS category 160 is further subdivided to include VUS, but suggesting pathogenic (score-5) 172, and VUS, but suggesting benign (score-3) 176.

As already stated, in an embodiment of the invention, the midpoint score of 4 may be considered baseline, with all variants beginning at this score before application of any criteria. Then, in an embodiment of the invention, point values ranging from −3 to +3 may be derived, e.g., from five types of data, with 0.5 being the smallest change in scoring. The sum of all point values was added to the starting score of 4 to produce a pathogenicity score ranging from 1 to 7.

In embodiments of the invention, certain variants or classes of variants may begin with scores other than in the midpoint of a scoring range. For example, in an embodiment of the invention, special consideration may apply to some genes where null variants (e.g. frameshift, nonsense, canonical splice site variants associated with out-of-frame events) have been documented in literature to cause well-characterized disease phenotypes. New variants of these kinds may be assigned, e.g., +2 points from the outset and thus begin with a score of 6 (likely pathogenic). But this special handling may not apply, e.g., (i) to null variants near the C terminus that are likely not subject to nonsense mediated RNA decay, (ii) to those variants occurring in a non-relevant isoform, and (iii) in gene-specific cases where the disease mechanism or molecular biology was well characterized.

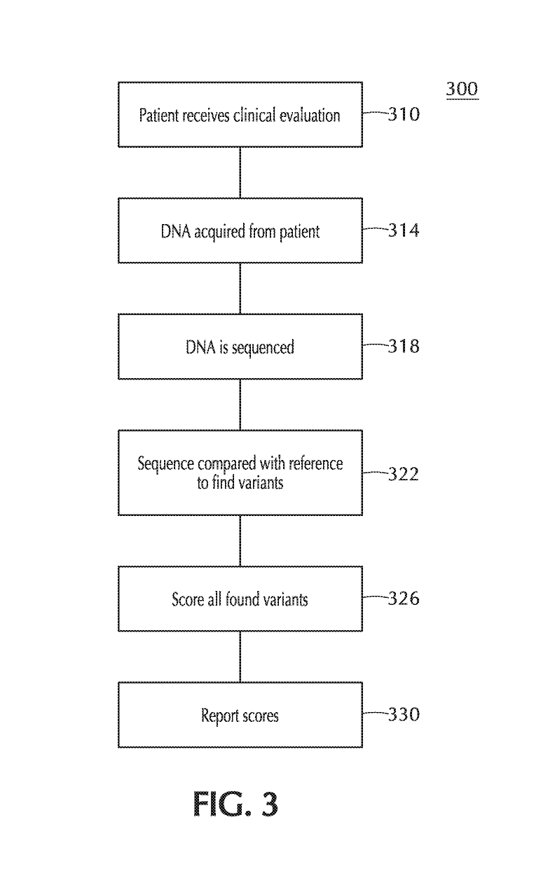

FIG. 3 depicts evaluation of variants in the context of a workflow 300 that may exist in connection with embodiments of the invention. As depicted, the flow 300 begins with a patient receiving a clinical evaluation in block 310, e.g., from a physician. It will be appreciated that sometimes a physician may order a genetic test to confirm a diagnosis, and some other times a physician will order the test to rule out a diagnosis. It will also be appreciated that a genetic test or sequencing may be ordered independent of any diagnostic setting, e.g., for research or statistical purposes.

In block 314 a tissue sample is obtained from the patient, from which DNA is to be extracted for sequencing. The type of tissue may vary depending, e.g., on the nature of the sequencing analysis. But in connection with an exemplary embodiment of the invention, a blood sample may be acquired. In block 318, DNA from the tissue sample is sequenced, e.g., according to one or more techniques such as are known in the art.

In block 322, the sequence is examined for variants. For example, in connection with an embodiment of the invention, the sequence may be aligned with a reference sequence such as the human transcript reference sequence maintained by the National Center for Biotechnology Information. Suitable tools for manipulating sequence data are known to those in the art and may include, e.g., versions of Alamut® Visual. Then, in block 326, the variants may be evaluated, e.g., as described below.

Finally, in block 330, results of the analysis may be provided. For example, a report may identify one or more variants and, for one of more of the variants, provide an evaluation according to embodiments of the invention. For one of more of the evaluated variants, some or all of the supporting data may be provided, and the supporting data may include information about how one or more variants were scored.

Scoring a variant according to embodiments of the invention may take place as described below. Although scoring is described here in the form of flows and decisions, these descriptions are illustrative examples of how the scoring criteria may be applied, and they are not intended to be limiting. It will be appreciated that scoring criteria may be applied in other ways in embodiments of the invention, including in ways that may not ordinarily be described as flows. It will further be appreciated that scoring processes may in embodiments of the invention proceed according to an ordering that differs from those described here in connection with illustrative examples.

Minor Evidence and Prediction Tools

In an embodiment of the invention, scoring a variant may begin with evaluating certain evidence (which is designated “minor evidence”) and considering predictions of the variant's effect, if any, on splicing.

Minor evidence, as the name suggests, is evidence that in itself holds relatively less predictive weight but may reinforce other kinds of evidence. In embodiments of the invention, it is certain evidence that may be based on prediction tools, important functional domains, known pathogenic variants at the same residue, and the report of an affected patient with the variant.

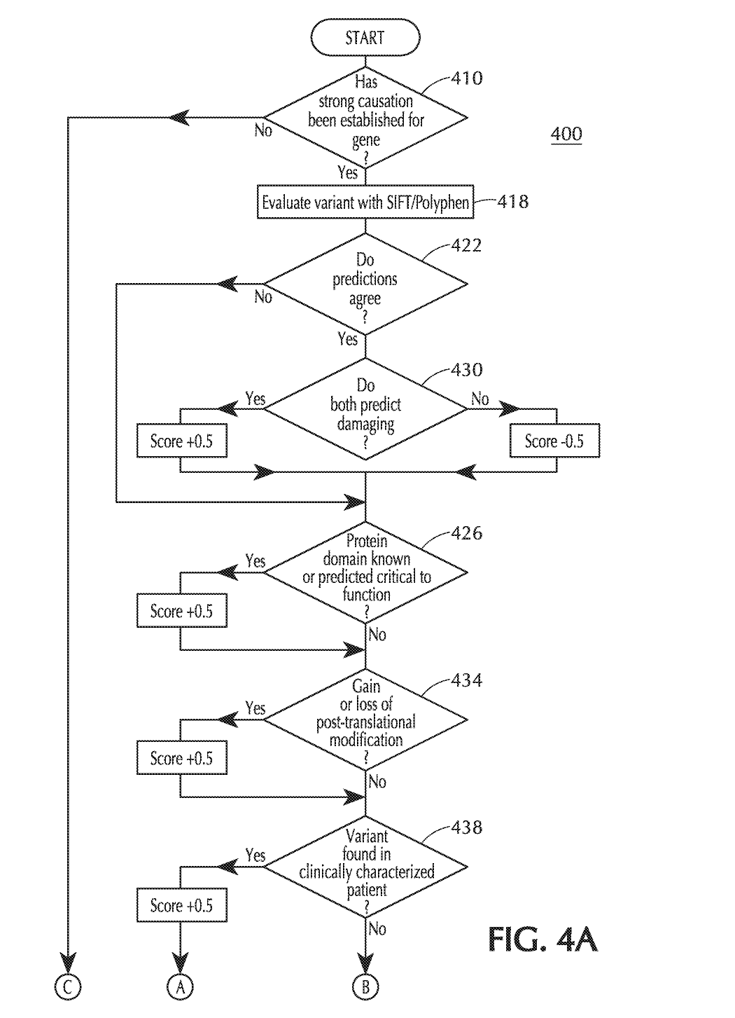

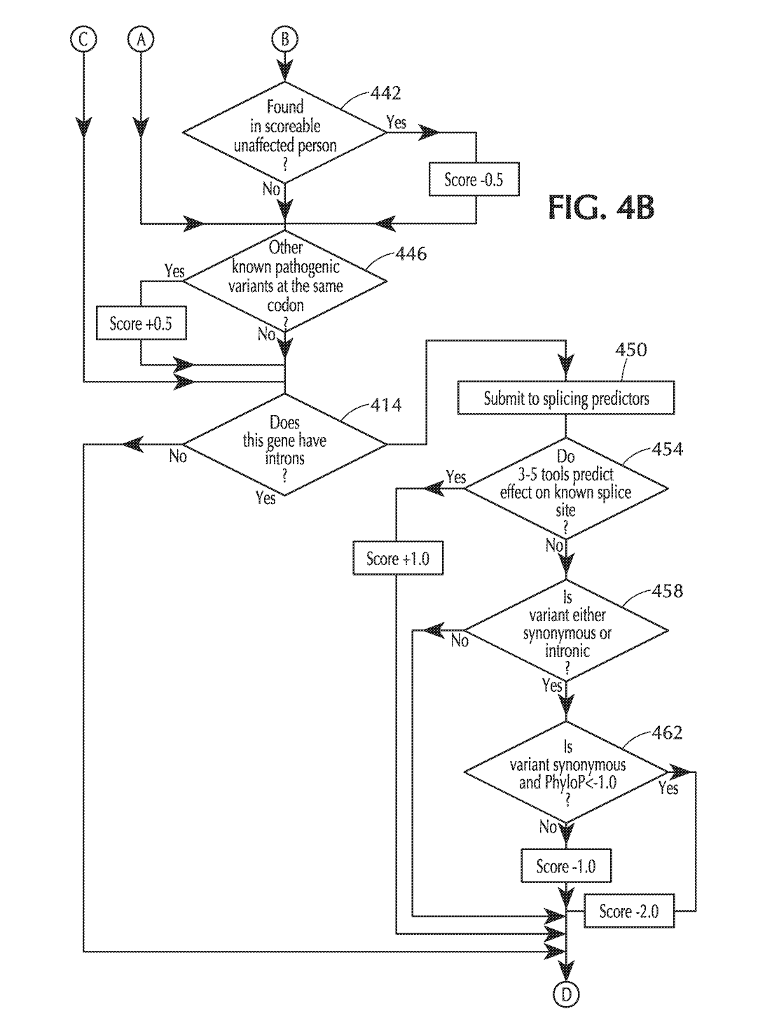

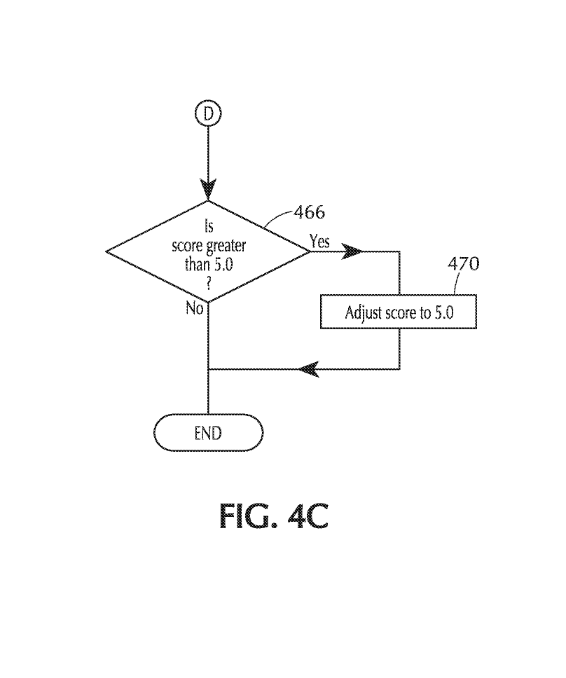

FIGS. 4a-4c depict the flow 400 of scoring a variant according to minor evidence and splicing predictions according to an embodiment of the invention. (These figures are referred to collectively as FIG. 4.) The flow begins in block 410 with determining whether disease causation has been strongly shown for the gene.

In connection with an embodiment of the invention, strongly showing disease causation may follow, e.g., guidelines established by ClinGen, which is a National Institutes of Health (NIH)-funded resource dedicated to building an authoritative central resource that defines the clinical relevance of genes and variants for use in precision medicine and research. ClinGen has developed a tiered framework for assessing the evidence that supports or refutes any claimed associations between genes and genetic disorders. (ClinGen publishes the current classification on their Web site, which has the domain name www.clinicalgenome.org; the document's filename is “current_clinical_validity_classifications.pdf”.) According to embodiments of the invention, minor evidence may be considered if “strong” supportive evidence of disease causation exists, according to the ClinGen classification scheme.

(Note that, as persons skilled in the art will recognize, associating a gene with a genetic disorder is not the same as establishing an association between a particular variant and the disorder.)

If it is determined in block 410 that minor evidence is not to be considered, then flow skips ahead to evaluating splicing predictions, which begins at block 414, discussed below. Otherwise, evaluation of minor evidence begins in block 418 with obtaining predictions of the variant's effect on protein function. In an embodiment of the invention, two tools may be used: SIFT (available at the Web site sift.jcvi.org) and PolyPhen-2 (available at genetics.bwh.harvard.edu). Both SIFT and PolyPhen-2 are publicly-available tools that predict the effects of genetic polymorphisms on protein function.

If SIFT and PolyPhen-2 differ regarding whether a variant is damaging, in block 422, the flow skips to the next minor evidence, beginning at block 426. Otherwise, in block 430, if the tools agree that the variant is likely damaging, 0.5 is added to the score, and if the tools agree that the variant is likely benign, 0.5 is subtracted.

Block 426 represents determining whether the variant affects a protein domain that is known to be critical to the function of the protein. (Note that showing that the variant affects a domain that is critical to the protein's function is not the same as showing that the variant actually does affect the function of that protein.) If the variant does affect such a domain, 0.5 is added to the score; otherwise, the score is unchanged.

Block 434 represents determining whether the variant leads to gain or loss of a post-translational modification (PTM) of the resulting protein. Examples of PTM may include phosphorylations, glycosylations, and methylation, among others. If the variant does cause a gain or loss, 0.5 is added to the score; otherwise, the score is unchanged.

Block 438 represents determining whether the variant has been identified in a patient who has been clinically characterized as affected by a disorder related to the gene in which the variant is found. If so, 0.5 is added to the score.

Alternatively, the flow proceeds to block 442 if the variant has been identified in a patient who has not been clinically characterized. The block represents determining whether, if the variant is pathological, the pathology would be expected to manifest in the patient's phenotype. For example, if a genetic disorder typically has onset late in life, it is determined in block 442 whether the patient is old enough that the disorder should have manifested by now. Similarly, block 442 includes determining whether the gene has sufficiently high penetrance. If it is determined in block 442 that any disorder related to the gene would be expected to be manifest, and the patient is not manifesting such a disorder, then the variant's score is reduced by 0.5.

In an embodiment such as FIG. 4 depicts, the final piece of minor evidence in this stage is evaluated in block 446, which represents determining whether other pathogenic variants are known at the same codon. This determination may be made, for example, by referring to any of a number of publicly-available databases of variants. Examples of such databases include, among others, the Human Gene Mutation Database (HGMD®) and Online Mendelian Inheritance in Man (OMIM®). If such variants are known in the art, the score is increased by 0.5.

The depicted flow 400 includes consideration of the predicted effect of the variant on splicing. It will be appreciated that splicing is relevant only to genes that include introns, so block 414 represents determining whether splicing is applicable. If not, then the flow skips evaluation of splicing and proceeds to block 466.

If the gene is known to have introns, then splicing becomes a consideration. In an embodiment of the invention, splicing is taken into account by using several automated tools to predict the effect of the variant on splicing and then adjusting the score based on the various tools' predictions. In an illustrative embodiment, five tools may be used: (1) the “SpliceSiteFinder-like” algorithms incorporated into Alamut® Visual; (2) MaxEntScan, which is available at http://genes.mit.edu/burgelab/maxent/Xmaxentscan_scoreseq.html; (3) NNSPLICE, which is available at http://www.fruitfly.org/seq_tools/splice.html; (4) GeneSplicer, which is available at http://www.cbcb.umd.edu/software/GeneSplicer/gene_spl.shtml; and (5) Human Splice Finder, which is available at http://www.umd.be/HSF3/.

The scoring according to an embodiment depends on the nature of the predictions that the tools make and how many tools make a particular prediction. If in block 454 it is found that 3-5 tools predict that the variant affects a known splice site, then the score is increased by 1.0.

If two or fewer tools predict that the variant affects a known splice site, then the scoring may depend on whether the variant is intronic, synonymous, or both. If the variant is found in block 458 to be neither intronic nor synonymous (and two or fewer tools predict an effect), then splicing does not affect the score, and the flow skips ahead to block 466. Also, if the variant is intronic or synonymous, and exactly two tools predict an effect on a known splice site, splicing does not affect the score in this case, either, and the flow skips to block 466.

If the variant is synonymous, a tool called phyloP is used to obtain a score that reflects the conservation of the nucleotide at that site, e.g., due to selection pressure. phyloP, well-known in the art, is freely available as part of a software package called PHAST and described in Pollard, et al., Detection of Nonneutral Substitution Rates on Mammalian Phylogenies, 20 Genome Res. 110 (2010), http://dx.doi.org/10.1101/gr.097857.109. If the phyloP score at the variant site is less than −1.0, then the variant's score is reduced by 2.0.

Otherwise, if the phyloP score exceeds −1.0, or if the variant is intronic and not synonymous, then the variant's score is reduced by 1.0.

Additionally, in an embodiment, exon variants predicted to cause cryptic splice sites but not to change natural splice sites do not affect the variant's score.

Finally, in an embodiment of the invention, the effects of minor evidence and splicing prediction on a variant's score are limited. Thus, if it is seen in block 466 that the variant has received a score greater than 5.0 as a result of this flow 400, the score is reduced in block 470 to the maximum value (at this stage) of 5.0.

Table 1 summarizes scoring a variant according to minor evidence and splicing predictions according to an embodiment of the invention.

TABLE I
Minor Evidence/Splicing Predictions
NOTE: Minor evidence can be combined to alter the score, but it cannot move the score above 5
without supporting evidence from another category-minor evidence alone is capped at 5. Minor
evidence is not applied if a strong disease causation has not been established for the gene.
Additionally, minor evidence (items A-E) will not be applied if the frequency is high enough to
warrant a point reduction. Splicing predictions (item F) will be discounted only if frequency warrants
a 3 point reduction in score. Gene-specific rule variations may also apply to account for disorders
with late or variable age of onset, disease/disorder severity, or reduced penetrance.

| | Score | |
|---|---|---|
| Outcome | Value | Notes |
| A. SIFT/Polyphen | | |
| (i) both predict damaging | +0.5 | |
| (ii) disagree | 0 | |
| (iii) both predict benign | −0.5 | |
| B. Protein Domain | | |
| (i) critical or proposed/predicted critical to | +0.5 | |
| function | | |
| (ii) unknown | 0 | |
| C. Post-Translational Modification (PTM) | | |
| (i) gain or loss | +0.5 | Include looking for phosphorylations, |
| | | glycosylations, methylation, etc., as |
| | | appropriate. |
| (ii) no change/not applicable | 0 | |
| D. Report in Patient/Control | | |
| (i) found in a clinically characterized | +0.5 | Cannot be part of a family that is being |
| patient | | used for segregation data. Do not use if |
| | | variant is seen enough in general |
| | | population to score variant down. |
| (ii) found in an unaffected person | −0.5 | Must be clearly past typical age of onset |
| | | and in a gene with high penetrance. |
| | | Genotype must match expected disease |
| | | model (viz., homozygous/cmp |
| | | heterozygous for recessive, heterozygous |
| | | for dominant). |
| E. Other Known Pathogenic Variants at | | |
| Same Codon | | |
| (i) one or more known or likely pathogenic | +0.5 | Truncating variants do not count. |
| (missense) variants at the same codon | | |
| F. Splicing Predictions | | NOTE: If a gene has no introns, do not |
| | | score or report splicing. |
| (ia) synonymous or intronic variant | −1.0 | Using 5 splicing predictors in Alamut ®. |
| predicted to have no effect on a known | | |
| splice site (0 or 1 algorithms, out of 5, | | |
| predict an effect), and PhyloP (nucleotide | | |
| conservation) is > −1.0 for synonymous | | |
| variant | | |
| (ib) synonymous variant predicted to have | −2.0 | |
| no effect on a known splice site (0 or 1 | | |
| algorithms predict an effect), and PhyloP | | |
| (nucleotide conservation) is < −1.0 | | |
| (ii) synonymous or intronic variant | 0 | |
| predicted to affect known splice site by 2 | | |
| algorithms or non-synonymous variant | | |
| predicted to affect known splice site by 0, | | |
| 1, or 2 algorithms | | |
| (iii) any variant predicted to affect known | +1.0 | |
| splice site by 3, 4, or 5 algorithms | | |
| (iv) any algorithm predicts gain of a novel | 0 | |
| splice site, known site unaffected | | |

Frequency Data in the General Population and Association Testing

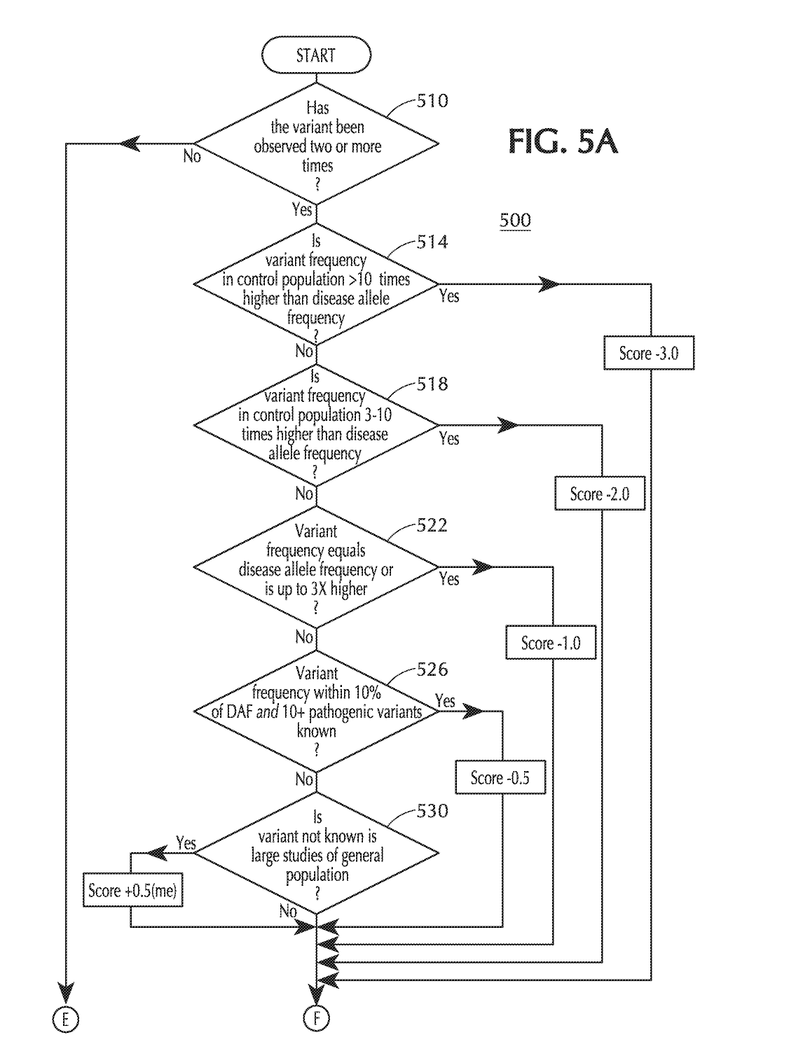

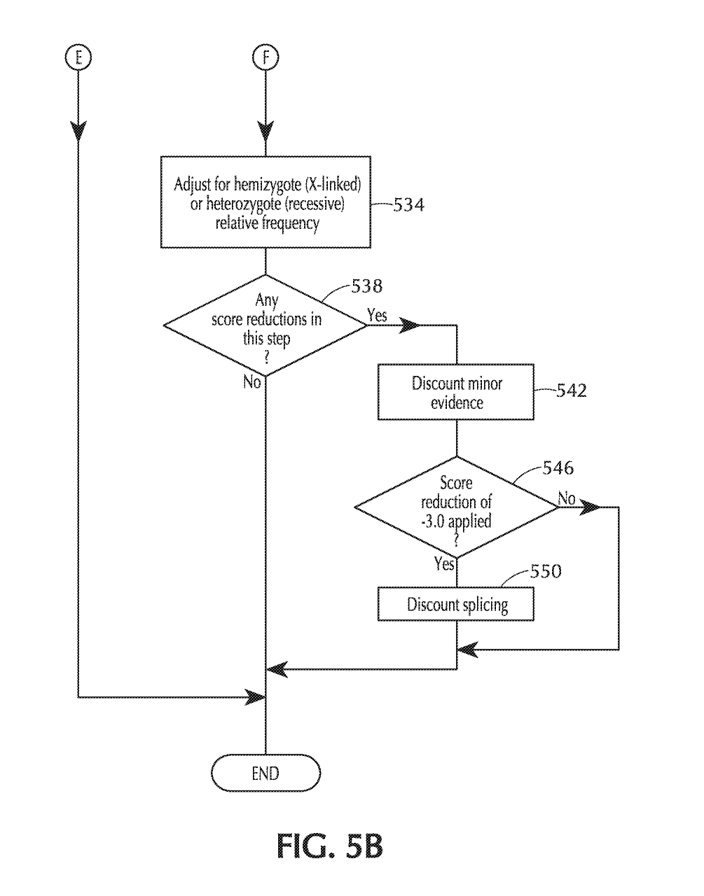

FIGS. 5a and 5b depicts a flow 500 of scoring a variant based on data about the frequency of the variant in the general population, according to an embodiment of the invention. (“General population” here may refer, e.g., to a population of people who have not been characterized as having a condition associated with variants in the gene under consideration or to a population of people who have been characterized as not having such a condition.) In connection with an embodiment of the invention, the population frequencies of variants were estimated from internal studies, published control groups, and data reported in dbSNP, 1000 Genomes, and the Exome Sequencing Project. The variant frequencies were compared to estimated disease allele frequencies, taking into account published information on disease prevalence, varying disease penetrance, and the gene-specific attributable risk in polygenic disorders. When making this estimation, a conservative approach was taken in calculating the disease allele frequency, to account for underestimates of disease prevalence.

According to an embodiment of the invention, this factor can affect the variant's score only if sufficient evidence exists of the variant's appearance. Thus, in block 510, it is determined whether the variant has been observed and reported by two separate sources. If not, the rest of this flow is skipped.

Otherwise, in an embodiment, if a variant has been found in block 514 to exceed the expected disease allele frequency by 10-fold, the variant's score may be reduced by 3 points. Pathogenicity scores may be reduced by 2 points if the observed frequency of the variant is found in block 518 to be 3-10 times above the estimated disease allele frequency and reduced by 1 point if the variant frequency is found in block 522 to equal or exceed the expected disease allele frequency by less that 3 times. In an embodiment of the invention, these rules may not apply when a founder variant is identified in the literature known to the art or if the variant has been found to be significantly enriched in a self-reported ethnic population.

If none of the above adjustments applies, in an embodiment of the invention, it is determined in block 526 whether the variant frequency is below the disease allele frequency, but within 10% of it, and at least 10 pathogenic variants of the gene are known. If so, the score may be reduced by 0.5 points, although this adjustment may be in an embodiment of the invention be treated as “minor evidence”, which was described in connection with FIGS. 4a-4c.

If in block 530 it is determined that the variant does not appear in any large studies of control or general populations, the score may in an embodiment be increased by 0.5. (The meaning of this criterion is further explained in Table 2.) This adjustment, too, may be treated as “minor evidence”.

The adjustments described above in connection with blocks 514-522 may be based on considerations of variants in a single autosomal gene. Thus, block 534 represents applying the same criteria and corresponding adjustments to hemizygote gene frequencies (for X-linked genes) or homozygote genotype frequencies (for recessive genes) that exceed the observed disease prevalence. For example, if homozygotic variants are observed more than 10 times as often in the general population as the disease is, then, in an embodiment of the invention, the score may be reduced by 3 points.

As discussed in connection with the flow 400 of FIGS. 4a-4c, “minor evidence” may be disregarded altogether if the variant's score is reduced based on frequency data. Thus, block 538 (FIG. 5b) represents determining in an embodiment whether any such reductions were made. If so, then block 542 represents further adjusting the score to discount any minor evidence. For example, if the variant's score was increased after block 426 (FIG. 4a) because the variant affected a protein domain that is known or predicted to be critical to the protein's function, that increase may be reversed in block 542 (FIG. 5b).

Further, in an embodiment of the invention, it may be determined in block 546 whether a score reduction of 3 points was applied due to frequency data, e.g., after block 514. If so, then any score adjustment due to splicing predictions may also be reversed.

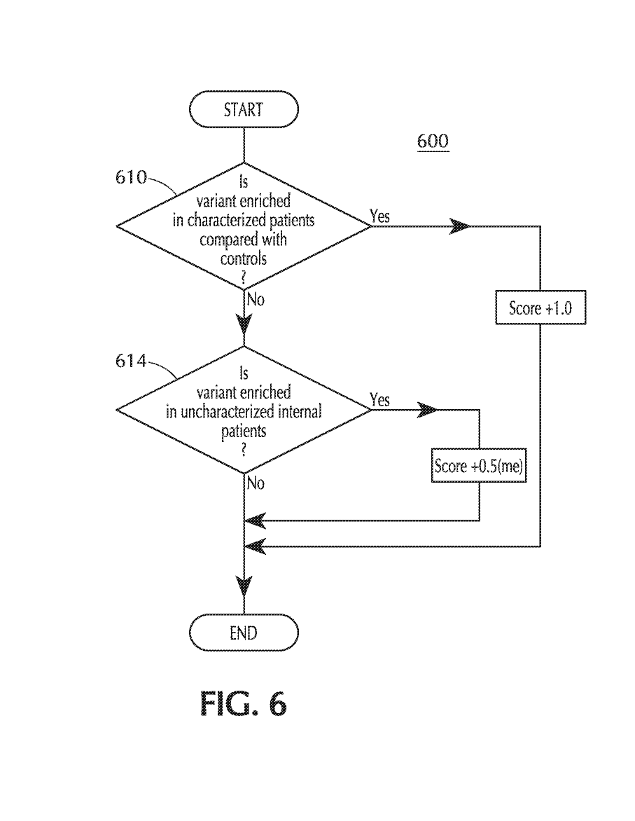

FIG. 6 depicts a flow 600 of scoring a variant based on association testing according to an embodiment of the invention. In block 610, it may be determined whether the variant is enriched in characterized patients relative to the general population. A “characterized patient” may be, e.g., a patient who has been diagnosed as having (or likely having) a disorder related to the gene in question. Determining whether the variant is enriched may rely on Fisher's exact test of the 2×2 table or, if the population size exceeds 10,000, then the chi-squared test with Yates' corrections may be used.

Otherwise, if the variant is not found to be enriched in characterized patients, it may nonetheless be determined in block 614 that the variant is enriched in “uncharacterized internal patients”. An uncharacterized internal patient, in connection with an embodiment of the invention, may be, e.g., a patient who has not been diagnosed with a genetic disorder but has nonetheless been tested because of concerns related to that gene. For example, the patient may be tested to rule out a genetic disorder or for screening based on family history.

If the variant is determined in block 614 to be enriched in uncharacterized internal patients, the score may be increased by 0.5 points, but this adjustment may in an embodiment of the invention be treated in some ways like minor evidence, discussed above. In an embodiment, for example, this adjustment may generally not be applied if other minor evidence is not applied, but it might be applied, despite being minor evidence, if other minor evidence was disqualified in block 542 (FIG. 5b) based only on frequency data.

Table 2 summarizes scoring a variant according to frequency data in the general population, and Table 3 summarizes scoring a variant according to association testing, according to embodiments of the invention.

TABLE 2
Frequency Data
NOTE: For this kind of data to be used, there must be two or more observations of this variant from
any source. If disease prevalence is not well established, the most conservative published estimate is
to be used. The frequency used can be from a public database, published data, or, if available,
internal data.

| | Score | |
|---|---|---|
| Outcome | Value | Notes |
| (i) variant frequency in control/general | −3.0 | The frequency must exceed 0.001 (and |
| population is > 10 times higher than disease | | there must be more than 10 occurrences |
| allele frequency | | if only one source of data is used); |
| | | document use of data from ExAC if it is |
| | | the only source. Can use the highest |
| | | frequency in a single ethnic population |
| | | within ExAC as long as that population |
| | | has more than 1,000 chromosomes. |
| (ii) variant frequency in control/general | −2.0 | If the only data is from ExAC or ESP, |
| population is 3-10 times higher than | | there must be 10 or more occurrences of |
| disease allele frequency | | the variant to score it as likely benign on |
| | | this basis; otherwise, if no other data is |
| | | available, the score must stay in the |
| | | VUS range. [Exceptions to the 10 |
| | | occurrence minimum may be allowed in |
| | | specific genes with generally severe, |
| | | early onset, and fully penetrant disease. |
| (iii) variant frequency in control/general | −1.0 | |
| population is equal to, or up to 3 times | | |
| higher, than disease allele frequency | | |
| (iv) variant frequency is below disease | −0.5 | This is meant for use in genes where |
| allele frequency, but within 10%, and there | | there is no attributable risk factor, and |
| are at least 10 known pathogenic variants | | the calculated disease allele frequency |
| in the gene. | | seems overly conservative. Treat as |
| | | minor evidence. |
| (v) variant is not seen in large | +0.5 | The variant must be absent in all |
| control/general population studies | | general population studies, and there |
| | | must be ExAC data from at least 80% of |
| | | the sample population (97,000 for |
| | | autosomes, 70,000 for X chromosomes). |
| | | treat as minor evidence. |
| (vi) hemizygote genotype frequency (for X- | −3.0 to | Follow scoring rules (i) to (iii) above; |
| linked gene) or homozygote genotype | −1.0 | can be used even if total |
| frequency (for recessive gene) is above | | frequency/heterozygote frequency does |
| disease prevalence | | not exceed disease allele frequency. |
| | | Must approximate Hardy-Weinberg |
| | | equilibrium (i.e., heterozygotes should |
| | | be much more common than |
| | | homozygotes). |

TABLE 3
Association Testing vs. Control Frequency Data
Use Fisher's exact test of 2 × 2 table to determine statistical significance.
If total N is over 10,000, then use chi-square test with Yates' corrections.

| | Score | |
|---|---|---|
| Outcome | Value | Notes |
| (i) variant is enriched in characterized | +1.0 | Must be statistically significant: use only |
| patients compared to controls | | when variant has been seen 6 or more |
| | | times in clinically documented patients |
| | | and with no ethnic bias. |
| (ii) variant is enriched in uncharacterized | +0.5 | Must be statistically significant using |
| internal patients | | chi-squared test: use only when variant |
| | | has been seen 6 or more times and have |
| | | at least 200 internal patients tested, but |
| | | since the internal patients are |
| | | uncharacterized, treat like minor |
| | | evidence without disqualification based |
| | | on frequency data. |

Variant Segregation Analysis in Families

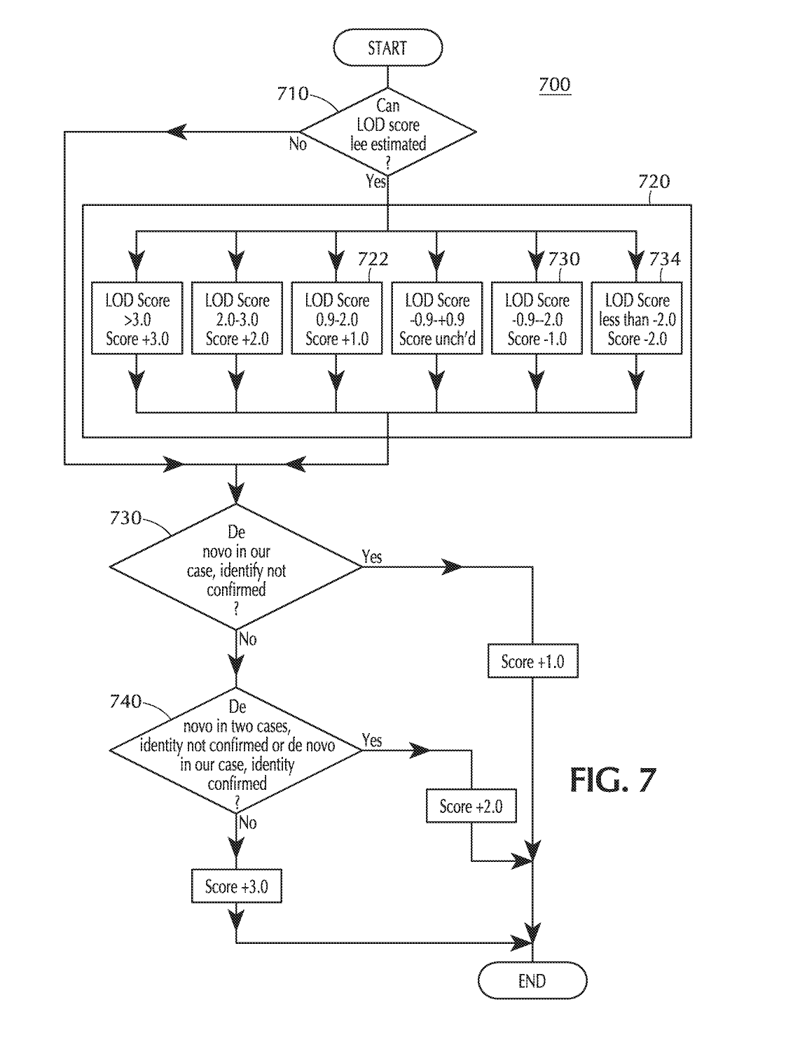

FIG. 7 depicts as a flow 700 scoring a variant according to analysis of the variant's segregation in family pedigrees. According to embodiments of the invention, the segregation of variants in family pedigrees may be analyzed by estimating the LOD score or by a statistical association test if the family data is incomplete.

The LOD score (Logarithm (base 10) Of Odds) is a statistical test, well known in the art, that is often used for linkage analysis in human, animal, and plant populations. The LOD score compares the likelihood of obtaining the test data if the two loci (or traits, or a marker and a trait) are indeed linked, to the likelihood of observing the same data purely by chance. Positive LOD scores favor the presence of linkage, whereas negative LOD scores indicate that linkage is less likely.

According to an embodiment of the invention, The LOD score may be estimated based on the number of meiotic events and weighted as evidence for the segregation between the disease locus and the variant in family pedigrees. The flow 700 begins at block 710 with determining whether an estimate of the LOD score can be made. The ability to make this estimate may depend, e.g., on the availability of information about the family pedigree, including information about the genotypes and phenotypes of family members in multiple generations. The Fisher's exact test may be used in an embodiment of the invention to calculate the statistical significance of variant segregation in pedigrees with incomplete family data, especially when the proband's siblings are tested without the parents.

In block 720, the variant's score is adjusted based on the range in which the LOD score falls. Table 4, below, also describes the adjustment ranges.

Block 730 represents determining whether a variant has appeared de novo in one patient whose parentage has not been confirmed by genetic testing. If so, the variant's score is increased by 1.0, but this adjustment cannot increase a variant's score above 5.0 if the only other evidence is minor evidence.

Block 740 represents determining whether the variant has appeared de novo in either: (i) one patient whose parentage has been confirmed by genetic testing or (ii) two patients whose parentage has not been confirmed. In either case, the variant's score is increased by 2.0, but only if the variant affects a gene in which de novo variants are known to occur. Also, this adjustment cannot increase a variant's score above 6.0 if the only other evidence is minor evidence.

Block 750 represents determining whether the variant has appeared de novo in either: (i) two or more patients whose parentage has been confirmed by genetic testing or (ii) three or more patients whose parentage has not been confirmed. In either case, the variant's score is increased by 3.0, but only if the variant affects a gene in which de novo variants are known to occur.

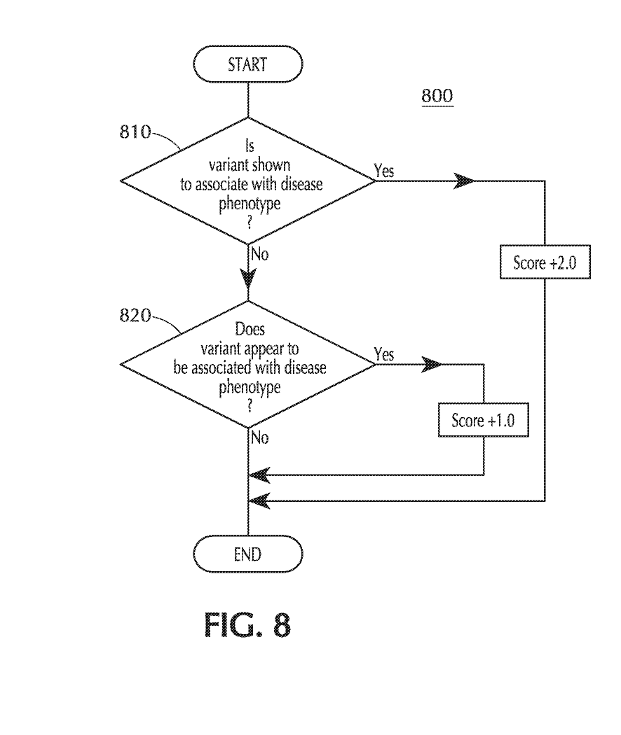

In addition to scoring a variant based on segregation within families, a variant may in an embodiment of the invention be scored based on association testing in family members. FIG. 8 depicts a flow 800 of scoring a variant on this basis. Block 810 represents determining whether the variant has been shown to associate with the disease phenotype in genotyped family members. If Fisher's exact test on a 2×2 table shows a statistically significant association (p<0.05), and if data is available from two or more families (including both diagnosed and undiagnosed members), the variant's score is increased by 2.0. Otherwise, if the variant only appears to associate with the disease phenotype in family members (0.05<p<0.1), then the variant's score is increased by 1.0, although the score is capped at 5.0 if all other evidence is minor evidence.

Table 4 summarizes scoring a variant according to segregation in families, and Table 5 summarizes scoring a variant according to association testing in family data, according to embodiments of the invention.

TABLE 4
Segregation in Families

| | Score | |
|---|---|---|
| Outcome | Value | Notes |
| (i) LOD score over 3.0 | +3.0 | Must be from multiple families and |
| | | include both affected and unaffected |
| | | offspring to score +3.0; if these |
| | | conditions do not apply and all other |
| | | evidence is minor, do not score above 6. |
| (ii) LOD score over 2.0 but under 3.0 | + 2.0 | Must be from multiple families and |
| | | include both affected and unaffected |
| | | offspring to score +2.0; if these |
| | | conditions do not apply and all other |
| | | evidence is minor, do not score above 6. |
| (iii) LOD score over 0.9 but under 2.0 | +1.0 | |
| (iv) LOD score over −0.9 but under 0.9 | 0 | |
| (v) LOD score over −2.0 but under −0.9 | −1.0 | |
| (vi) LOD score less than −2.0 | −2.0 | Must be from multiple families. |
| (vii) de novo in one case, identity not | +1.0 | Unconfirmed de novo cannot move score |
| confirmed | | above 5.0 if all other evidence is minor |
| | | evidence. |
| (viii) de novo in one case, identity | +2.0 | Must be a gene where de novo mutations |
| confirmed, or in two cases not confirmed | | are known to occur. Cannot move score |
| | | above 6 if all other data is minor |
| | | evidence. |
| (ix) de novo in two cases, identity confirmed, | +3.0 | Must be a gene where de novo mutations |
| or in three cases not confirmed | | are known to occur. |

TABLE 5
Association Testing in Family Data
Use Fisher's exact test of 2 × 2 table to determine statistical significance.

| | Score | |
|---|---|---|
| Outcome | Value | Notes |
| (i) variant associates with | +2.0 | Must be statistically significant |
| disease phenotype in | | association (p < .05), and must |
| genotyped family members | | include both affected and |
| | | unaffected family members. |
| | | Must have data from two or more |
| | | families. |
| (ii) variant appears to associate | +1.0 | Must have marginal statistical |
| with disease phenotype in | | significance (.05 < p < .1). |
| genotyped family members | | Score caps at 5 if all other |
| | | evidence is minor. |

Co-Occurrence

“Co-occurrence” may refer to the presence of two or more variants that are paired together in the same gene or in another gene related to the same disease. Variants that co-occur with otherwise positive results (i.e., a known pathogenic variant in dominant disorders or two pathogenic variants in recessive disorders) may be less likely to be pathogenic and may therefore receive lower scores according to embodiments of the invention. Additionally, recessive variants that co-occur less than expected with recessive pathogenic variants in trans may also be less likely to be pathogenic.

Conversely, if a variant in a recessive gene co-occurs frequently in trans with a single known pathogenic variant, but not with second variants in controls, then the variant may be more likely to be pathogenic.

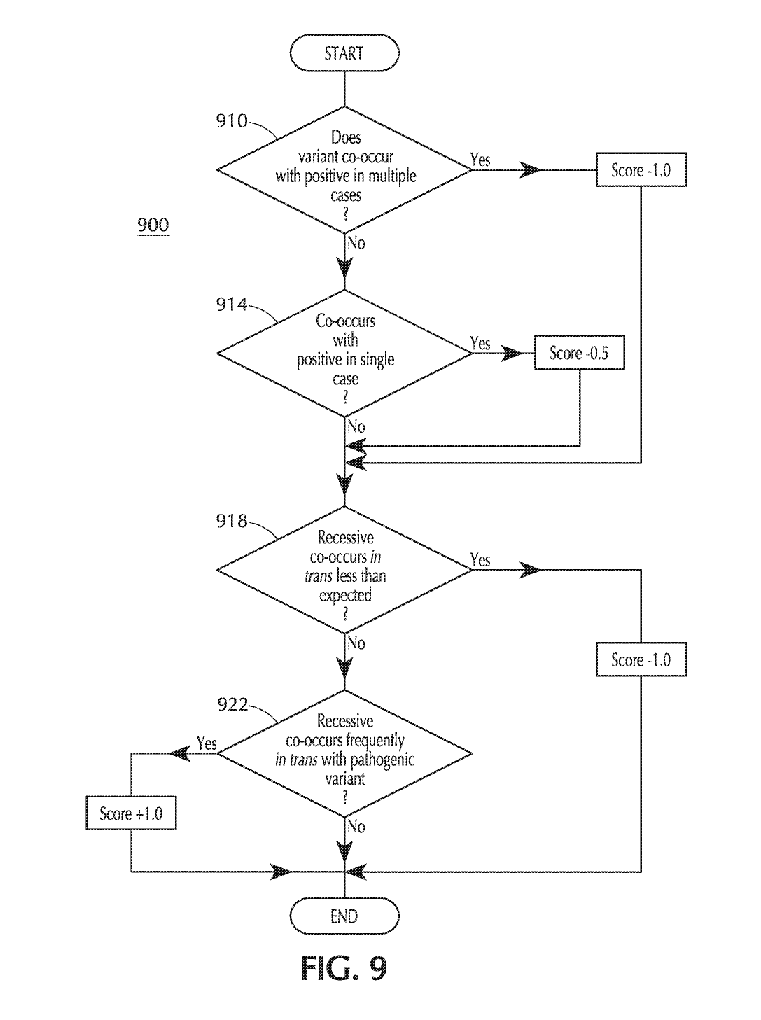

FIG. 9 depicts a flow 900 of scoring a variant according to co-occurrence in an embodiment of the invention. The flow begins in block 910 with determining whether the variant co-occurs with an otherwise positive result (i.e., a single pathogenic or predicted pathogenic variant in a dominant gene or two in a recessive gene) in multiple cases of the disorder associated with the gene that contains the variant that is being scored. According to an embodiment, the variant must be found in two or more patients if it is present in a dominant gene or in a recessive gene where the co-occurrences are in the same gene. Otherwise, the variant must be found in three or more patients, and the portion of patients must be statistically significant using the binomial test. If these criteria are met, the variant's score may be reduced by 1.0.

Otherwise, it is determined in block 914 whether the variant has been observed to co-occur with an otherwise positive result in any cases. (Again, if the gene is recessive, the positive results must affect the same gene as the variant that is being scored.) If these criteria are met, the score may be reduced by 0.5, but this adjustment may be treated as minor evidence and therefore may not apply in the circumstances discussed above.

In block 918 it is determined whether a variant in a recessive gene co-occurs with only one other known pathogenic variant in the same gene in multiple cases. According to embodiments of the invention, it may be required that the variant be observed in at least three cases of the disorder associated with the gene, and the variant being scored must be enriched in a statistically significant portion of patient, determined using the binomial test. If these criteria are met, the variant's score may be increased by 1.0.

In block 922 it is determined whether the variant co-occurs with other known pathogenic variants less often than might be expected given the prevalence of those variants in the general population or population under study. Again, the variation must be statistically significant, using the binomial test. If these criteria are met, in an embodiment, the variant's score may be increased by 1.0.

Table 6 summarizes scoring a variant according to co-occurrence according to an embodiment of the invention.

TABLE 6
Co-occurrence

| | Score | |
|---|---|---|
| Outcome | Value | Notes |
| (i) variant co-occurs with otherwise positive | −0.5 | Treat as minor evidence. If recessive, |
| result (single pathogenic or predicted | | use only if positives are in that same |
| pathogenic variant in a dominant gene or | | gene as the variant being scored. |
| two in a recessive gene) in a single case | | |
| (ii) variant co-occurs with otherwise positive | −1.0 | Requires 2 or more cases for a |
| result in multiple cases | | dominant gene or for a recessive gene |
| | | where the co-occurrences are in the |
| | | same gene. In all other cases, there must |
| | | be 3 or more occurrences, and in a |
| | | statistically significant portion of |
| | | patients. |
| (iii) variant in recessive gene co-occurs with | +1.0 | There must be 3 or more cases and a |
| one additional known pathogenic variant | | statistically significant portion of |
| in the same gene in multiple cases | | patients (i.e., single co-occurrences |
| | | should be enriched in patients with this |
| | | variant as compared to the expected |
| | | number based on the carrier frequency |
| | | for the gene). |
| (iv) The variant co-occurs with positives less | +1.0 | The must be statistically significant |
| often than expected. | | when compared against the positive rate |
| | | for the gene test or panel, using the |
| | | binomial test. |

Functional Studies

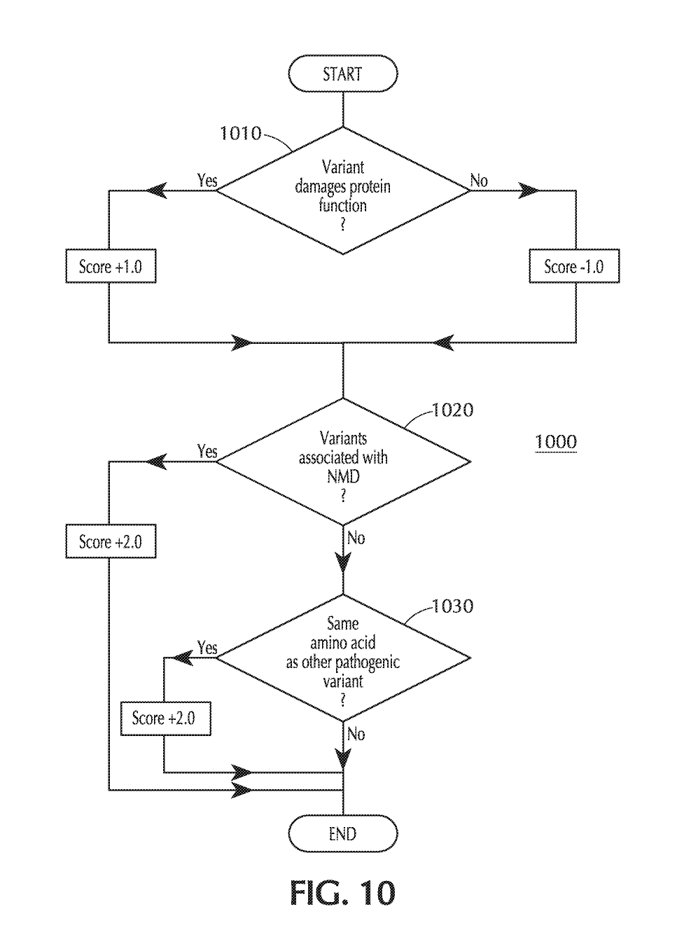

According to an embodiment of the invention, a variant may be scored based on its functional significance, based, e.g., on in vitro and in vivo published studies that showed whether or not a variant damaged the normal function of a protein. FIG. 10 depicts a flow of scoring a variant based on its functional significance according to an embodiment of the invention.

Block 1010 represents determining whether the variant has been shown to damage the function of a protein in a way that is relevant to the molecular basis of disease. If the published evidence in the art indicates that the variant does damage protein function in these ways, then the variant's score may be increased by 1.0. Conversely, if the published evidence in the art affirmatively concludes that the variant does not damage the protein in relevant ways, the score may be decreased by 1.0.

Block 1020 represents determining that the variant is a frameshift, nonsense, or canonical splice site variant that will lead to nonsense-mediated decay, which, in the gene containing the variant, has been demonstrated in the literature to be associated with a well-characterized disease phenotype. If this determination is made, in an embodiment of the invention, the variant's score may be increased by 2.0. If, in addition, the variant is found in a clinically characterized patient (as described under Minor Evidence, above), and the variant affects a dominant gene and is either absent from a large, multi-ethnic control population or occurs less frequently (to a statistically significant degree) in the general population, the variant's score may be increased by an additional 1.0.

Block 1030 represents determining in an embodiment of the invention that the variant results in an amino acid change that is identical to that of another variant that has previously been scored as pathogenic, but as a result of nucleotide change that is different from that of the other variant. In other words, block 1030 represents determining that the variant being scored is synonymous with another pathogenic variant. If this criterion is met, the variant's score may be increased by 2.0. As above, if the variant is also found in a clinically characterized patient (as described under Minor Evidence, above), and the variant affects a dominant gene and is either absent from a large, multi-ethnic control population or occurs less frequently (to a statistically significant degree) in the general population, the variant's score may be increased by an additional 1.0.

Table 7 summarizes scoring a variant according to functional studies according to embodiments of the invention.

TABLE 7
Functional Studies

| | Score | |
|---|---|---|
| Outcome | Value | Notes |
| (i) variant is damaging to protein function | +1.0 | The protein function must be relevant |
| | | to the molecular basis of disease. For |
| | | this adjustment to raise the variant's |
| | | score to 6.0 or higher, there must be at |
| | | least one known case of the variant in a |
| | | clinically affected patient. |
| (ii) variant has no impact on protein | −1.0 | The protein function must be relevant |
| function | | to the molecular basis of disease, and |
| | | this determination must be made based |
| | | on a complete analysis of all functions |
| | | of the protein that are known to be |
| | | relevant to disease. |
| A. Structural Impact | | |
| (iii) frameshift, nonsense, and canonical | +2.0 | The loss-of-function disease model must |
| splice site variants associated with well- | | be demonstrated in literature or |
| characterized disease phenotypes that | | through multiple documented |
| will lead to nonsense-mediated decay | | observations of null/truncating variants |
| | | occurring across the entirety of the gene |
| | | in patients. Demonstration of the |
| | | expected phenotype's occurrence with |
| | | the variant (as in table 1), as well as the |
| | | variant's absence (dominant genes) from |
| | | a large multi-ethnic control population |
| | | or appropriately low frequency in a |
| | | general population will add additional |
| | | +1.0 points and lead to a classification of |
| | | the variant to pathogenic. Note that |
| | | variants in the last exon of a gene may |
| | | escape nonsense-mediated decay and |
| | | therefore not follow this rule. |
| (iv) nucleotide variation is different but | +2.0 | This line of evidence may apply if |
| results in the same amino acid change of | | splicing predictions to not show a |
| a variant previously scored as | | difference in splicing profiles between |
| pathogenic | | the two variants. Demonstration of the |
| | | expected phenotype's occurrence with |
| | | the variant (as in table 1), as well as the |
| | | variant's absence (dominant genes) from |
| | | a large multi-ethnic control population |
| | | or appropriately low frequency in a |
| | | general population will add additional |
| | | +1.0 points and lead to classification of |
| | | the variant to pathogenic. |

Implementation

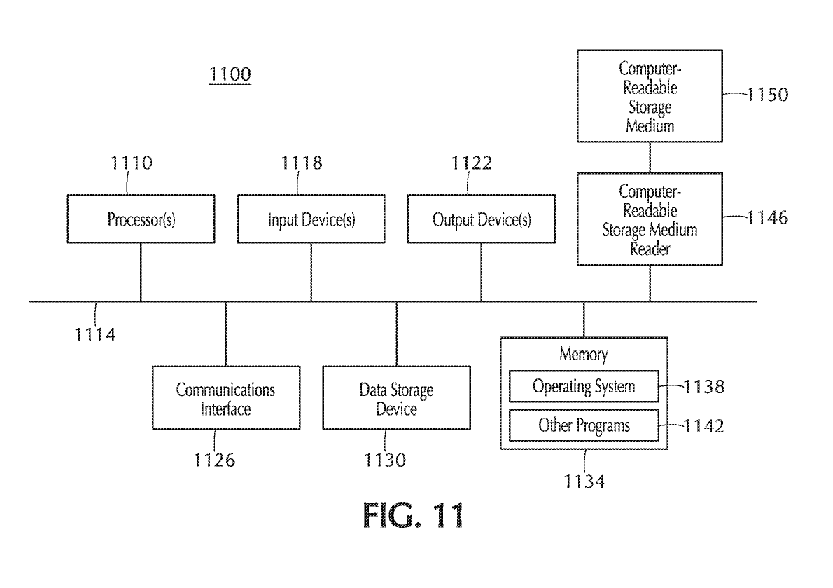

Embodiments of the invention may be implemented using (or in connection with) one or more computer systems, and such computer systems may, in connection with an embodiment of the invention, interact using one or more computer networks. FIG. 11 depicts an example of one such computer system 1100, which includes at least one processor 1110, such as, e.g., an Intel or Advanced Micro Devices microprocessor, which may be coupled to a communications channel or bus 1114. The computer system 1100 further includes at least one input device 1118 such as, e.g., a keyboard, mouse, touch pad or screen, or other selection or pointing device, at least one output device 1122 such as, e.g., an electronic display device, at least one communications interface 1126, at least one data storage device 1130 such as a magnetic disk or an optical disk, and memory 1134 such as ROM and RAM, each coupled to the communications channel 1114. The communications interface 1126 may be coupled to a network (not depicted) such as the Internet.

Although the computer system 1100 is shown in FIG. 11 to have only a single communications channel 1114, a person skilled in the relevant arts will recognize that a computer system may have multiple channels (not depicted), including for example one or more busses, and that such channels may be interconnected, e.g., by one or more bridges. In such a configuration, components depicted in FIG. 11 as connected by a single channel 1114 may interoperate, and may thereby be considered to be coupled to one another, despite being directly connected to different communications channels.

One skilled in the art will recognize that, although the data storage device 1130 and memory 1134 are depicted as different units, the data storage device 1130 and memory 1134 can be parts of the same unit or units, and that the functions of one can be shared in whole or in part by the other, e.g., as RAM disks, virtual memory, etc. It will also be appreciated that any particular computer may have multiple components of a given type, e.g., processors 1110, input devices 1118, communications interfaces 1126, etc.

The data storage device 1130 and/or memory 1134 may store instructions executable by one or more processors or kinds of processors 1110, data, or both. Some groups of instructions, possibly grouped with data, may make up one or more programs, which may include an operating system 1138 such as, e.g., Microsoft Windows®, Linux®, Mac OS®, or Unix®. Other programs 1142 may be stored instead of or in addition to the operating system. It will be appreciated that a computer system may also be implemented on platforms and operating systems other than those mentioned. Any operating system 1138 or other program 1142, or any part of either, may be written using one or more programming languages such as, e.g., Java®, C, C++, Objective-C, Visual Basic®, VB.NET®, Perl, Ruby, Python, or other programming languages, possibly using object oriented design and/or coding techniques.

One skilled in the art will recognize that the computer system 1100 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 1146, such as, e.g., a magnetic disk drive, magneto-optical drive, optical disk drive, or flash drive, may be coupled to the communications channel 1114 for reading from a CRSM 1150 such as, e.g., a magnetic disk, a magneto-optical disk, an optical disk, or flash memory. Alternatively, one or more CRSM readers may be coupled to the rest of the computer system 1100, e.g., through a network interface (not depicted) or a communications interface 1126. In any such configuration, however, the computer system 1100 may receive programs and/or data via the CRSM reader 1146. Further, it will be appreciated that the term “memory” herein is intended to include various types of suitable data storage media, whether permanent or temporary, including among other things the data storage device 1130, the memory 1134, and the CSRM 1150.

(The term “computer readable storage medium” specifically excludes transitory propagating signals, which should be apparent from the use of the word “storage”.)

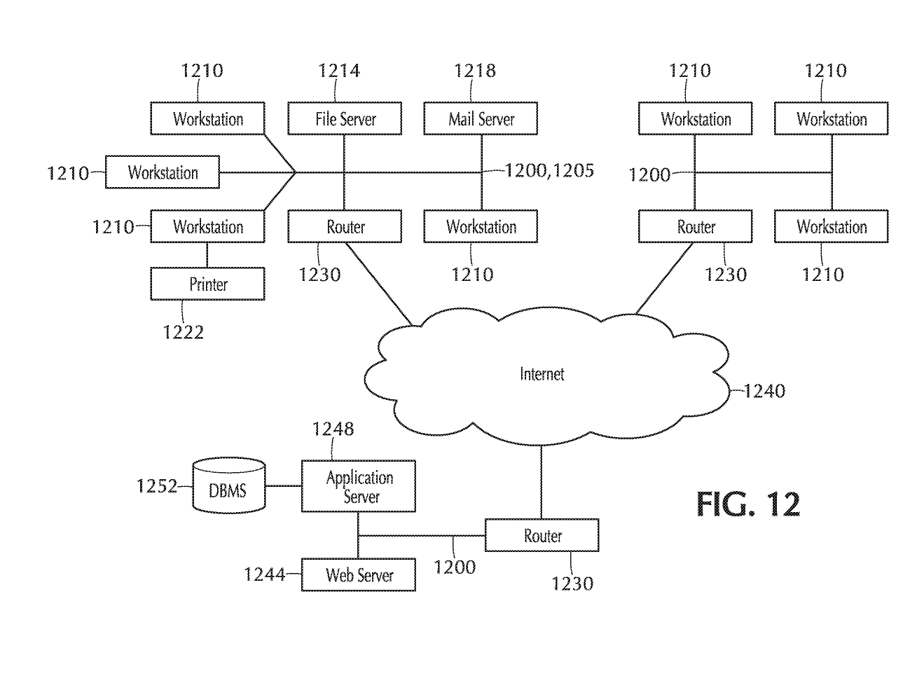

Two or more computer systems 1100 may communicate, e.g., in one or more networks, via, e.g., their respective communications interfaces 1126 and/or network interfaces (not depicted). FIG. 12 is a block diagram depicting an example of such interconnected networks 1200. Network 1205 may, for example, connect one or more workstations 1210 with each other and with other computer systems, such as file servers 1214 or mail servers 1218. A workstation 1210 may comprise a computer system 1100 (FIG. 11). The connections between devices may be achieved tangibly, e.g., via Ethernet® or optical cables, or wirelessly, e.g., through use of modulated microwave signals according to the IEEE 802.11 family of standards. A computer workstation 1210 or system 1100 that participates in the network may send data to another computer workstation system in the network via the network connection.

One use of a network 1205 (FIG. 12) is to enable a computer system to provide services to other computer systems, consume services provided by other computer systems, or both. For example, a file server 1214 may provide common storage of files for one or more of the workstations 1210 on a network 1205. A workstation 1210 sends data including a request for a file to the file server 1214 via the network 1205 and the file server 1214 may respond by sending the data from the file back to the requesting workstation 1210.

Further, a computer system may simultaneously act as a workstation, a server, and/or a client. For example, as depicted in FIG. 12, a workstation 1210 is connected to a printer 1222. That workstation 1210 may allow users of other workstations on the network 1205 to use the printer 1222, thereby acting as a print server. At the same time, however, a user may be working at the workstation 1210 on a document that is stored on the file server 1214.

The network 1205 may be connected to one or more other networks, e.g., via a router 1230. A router 1230 may also act as a firewall, monitoring and/or restricting the flow of data to and/or from the network 1205 as configured to protect the network. A firewall may alternatively be a separate device (not pictured) from the router 1230.

An internet may comprise a network of networks 1205. The term “the Internet” refers to the worldwide network of interconnected, packet-switched data networks that uses the Internet Protocol (IP) to route and transfer data. For example, a client and server on different networks 1200 may communicate via the Internet 1240, e.g., a workstation 1210 may request a World Wide Web document from a Web server 1244. The Web server 1244 may process the request and pass it to, e.g., an application server 1248. The application server 1248 may then conduct further processing, which may include, for example, sending data to and/or receiving data from one or more other data sources. Such a data source may include, e.g., other servers on the same computer system 800 or LAN 1200, or a different computer system or LAN and/or a database management system (“DBMS”) 1252.

As will be recognized by those skilled in the relevant art, the terms “workstation,” “client,” and “server” are used herein to describe a computer's function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

The terms “client” and “server” may describe programs and running processes instead of or in addition to their application to computer systems described above. Generally, a software client may consume information and/or computational services provided by a software server.

Embodiments of the invention may use the Web or related technologies. Information may be provided to a user in the form of one or more Web pages. A Web page may include one or more of text, sound, still and moving pictures, and other media, and it may be assembled from one or more files and/or other units accessed from one or more servers and/or other computer systems. Some or all of the content of the page may be generated dynamically, e.g., by one or more servers, and some or all of the content of the page may be generated and/or modified dynamically by the user agent (or browser), e.g., through JavaScript and/or other client-side scripting technologies.

The descriptions herein of computers, computer systems, networks, the Internet, and the World Wide Web are intended only for illustration and identification. No such description should be taken to mean that any of those terms are given meanings other than the ordinary and customary meanings of those terms in the relevant arts.

One or more computer systems may perform various steps of a method according to an embodiment of the invention. For example, given a sequence of nucleotides, a computer system may carry out comparisons between the sequence and a reference genome, e.g., as in block 322 of FIG. 3, to find variants. Indeed, considering the volume of data that must be examined, this step almost certainly will be carried out automatically by one or more computer systems.

Similarly, one or more data retrieval, comparison, and/or scoring steps described above may be automatically performed, individually or in combination, by one or more computer systems. (“Automatically” here may mean, e.g., that the computer system is provided initially with data and a direction to carry out the step or steps and then algorithmically carries out the step or steps without further human input.)

Validation of the Method

Validation of the methods disclosed herein is described in Karbassi, et al., A Standardied DNA Variant Scoring System for Pathogenicity Assessments in Mendelian Disorders, 37 HUM. MUTATION 127 (2015), http://dx.doi.org/10.1002/humu.22918, which derives from the present inventors' work and is hereby incorporated herein by reference.

We claim:

1. A method of assigning a score to a genetic variant that is based on multiple scoring criteria and reflects an estimate of pathogenicity of the variant, the method comprising:
identifying the variant in sequenced DNA obtained from a patient;
assigning a starting score to the variant, the starting score being a single numeric value that is associated with variants of unknown significance;
calculating a first score adjustment that is based on objective evaluation of minor evidence and splicing predictions;
calculating a second score adjustment that is based on objective evidence of the frequency with which the variant occurs in a general population;
calculating a third score adjustment that is based on objective evidence of the frequency with which the variant occurs in clinically characterized patients;
calculating a fourth score adjustment that is based on objective evidence of the frequency with which the variant has been observed to co-occur with one or more other variants that are known to be pathogenic;
calculating a fifth score adjustment that is based on objective evidence of a degree to which the variant exhibits segregation within one or more families;
calculating a sixth score adjustment that is based on objective evidence of association between the variant and one or more disease phenotypes within data describing one or more families;
calculating a seventh score adjustment based on objective evidence regarding whether the variant affects functions of one or more proteins that are known to be associated with disease;
calculating a variant score based on the starting value, the first score adjustment, the second score adjustment, the third score adjustment, the fourth score adjustment, the fifth score adjustment, the sixth score adjustment, and the seventh score adjustment, the variant score being a single numeric value; and
assigning the variant to an assigned classification based solely on the variant score, the assigned classification being one of a group that consists of a plurality of classifications, each classification in the plurality being associated with a respective different evaluation of variant pathogenicity.
